(19) United States
(12) Patent Application Publication
(10) Pub. No.: US 2026/0160584 A1
(43) Pub. Date: Jun. 11, 2026

(54) Assemblies and Methods Associated with a Flow Meter Insert

(71) Applicant: Sun Hydraulics, LLC, Sarasota, FL (US)

(72) Inventors: Bernd Zähe, Linnich (DE); Vinoad Chavaan, Pune State (IN)

(21) Appl. No.: 18/973,294

(22) Filed: Dec. 9, 2024

(51) Int. Cl. G01F 1/90; G01F 15/18

(52) U.S. Cl. CPC G01F 1/90; G01F 15/18

(57) ABSTRACT

An example flow meter insert includes a housing; a shaft mounted partially within the housing such that the shaft protrudes outside the housing; a turbine that is rotatably coupled to the shaft, wherein the turbine comprises an impeller mounted to the shaft external to the housing; a plurality of magnets, wherein the turbine is configured to rotate as fluid flows across the impeller, thereby causing the plurality of magnets to rotate therewith; and a sensor mounted adjacent the plurality of magnets to detect variation in a magnetic field as the plurality of magnets rotate along with the impeller, wherein, based on detecting the variation, the sensor is configured to provide information indicative of a count of revolutions and direction of rotation of the impeller to facilitate determining fluid flow rate and direction of fluid flow.

### BACKGROUND

Fluid systems involve using pressurized fluids to generate, control, and transmit power. In a hydraulic system, for example, a liquid such as or hydraulic fluid (e.g., mineral oil) is pumped through hydraulic cylinders and/or motors in a machine to operate implements of such machine.

In some applications, it may be desirable to measure or sense the fluid flow rate through the system. This may be accomplished by measuring the stroke of a movable element (e.g., a spool, piston, or poppet) of a valve, but such measurement might not be accurately correlated with the flow rate under some conditions and might not be feasible in some applications.

A separate flow meter may be added to the system, downstream or upstream from a valve or other components. The hydraulic line between the valve and the flow meter has a capacitance, and such capacitance may cause a delay in the flow measurement by the flow meter. As such, it may be desirable to integrate flow sensing capability into a manifold having multiple valves or components to reduce or eliminate such capacitance. It may also be desirable to reduce the pressure drop of fluid as it flows across the flow meter to enhance the system's efficiency. It is with respect to these and other considerations that the disclosure made herein is presented.

### SUMMARY

The present disclosure describes implementations that relate to assemblies and methods associated with a flow meter insert.

In a first example implementation, the present disclosure describes a flow meter insert. The flow meter insert includes: a housing; a shaft mounted partially within the housing such that the shaft protrudes outside the housing; a turbine that is rotatably coupled to the shaft, wherein the turbine comprises an impeller mounted to the shaft external to the housing; a plurality of magnets, wherein the turbine is configured to rotate as fluid flows across the impeller, thereby causing the plurality of magnets to rotate therewith; and a sensor mounted adjacent the plurality of magnets to detect variation in a magnetic field as the plurality of magnets rotate along with the impeller, wherein, based on detecting the variation, the sensor is configured to provide information indicative of a count of revolutions and direction of rotation of the impeller to facilitate determining fluid flow rate and direction of fluid flow.

In a second example implementation, the present disclosure describes an assembly of a manifold having a manifold having a manifold cavity, a first port, a second port, and a recess; and the flow meter insert of the first example implementation wherein the impeller is accommodated within the recess of the manifold, wherein the turbine is configured to rotate as fluid flows from the first port across the impeller to the second port or from the second port across the impeller to the first port.

In a third example implementation, the present disclosure describes a method of assembling the flow meter insert of the first example implementation or the assembly of the second example implementation.

In a fourth example implementation, the present disclosure describes a method of operating the flow meter insert of the first example implementation or the assembly of the second example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a cross-sectional side view of a flow meter insert, according to an example implementation.

FIG. 2A illustrates a cross-sectional side view of a housing of the flow meter insert of FIG. 1, according to an example implementation.

FIG. 2B illustrates a front view of the housing of FIG. 2A, according to an example implementation.

FIG. 3A illustrates a cross-sectional side view of a holder of the flow meter insert of FIG. 1, according to an example implementation.

FIG. 3B illustrates a front view of the holder of FIG. 3A, according to an example implementation.

FIG. 4 illustrates a partial front view of the flow meter insert of FIG. 1, according to an example implementation.

FIG. 5 illustrates a partial rear view of a shaft of the flow meter insert of FIG. 1 with a plurality of magnets disposed therein, according to an example implementation.

FIG. 6 illustrates a partial cross-sectional view of an assembly of the flow meter insert of FIG. 1 disposed in a manifold cavity of a manifold, according to an example implementation.

FIG. 7 is a graph showing frequency of a signal generated by the flow meter insert of FIG. 1 versus actual fluid flow rate, according to an example implementation.

### DETAILED DESCRIPTION

Within examples, disclosed herein are an insert for flow rate sensing (flow meter), an assembly of the insert with a manifold, and methods of assembling and operating the insert and assembly.

In an example, the flow meter insert includes a housing; a shaft mounted partially within the housing such that the shaft protrudes outside the housing; a turbine that is rotatably coupled to the shaft, wherein the turbine comprises an impeller mounted to the shaft external to the housing; a plurality of magnets, wherein the turbine is configured to rotate as fluid flows across the impeller, thereby causing the plurality of magnets to rotate therewith; and a sensor mounted adjacent the plurality of magnets to detect variation in a magnetic field as the plurality of magnets rotate along with the impeller, wherein, based on detecting the variation, the sensor is configured to provide information indicative of a count of revolutions and direction of rotation of the impeller to facilitate determining fluid flow rate and direction of fluid flow.

The term “turbine” is used herein to indicate rotary mechanical device including a rotary component such as an impeller, for example, which extracts energy from a fluid flow. As fluid flows across the turbine, fluid rotates the turbine.

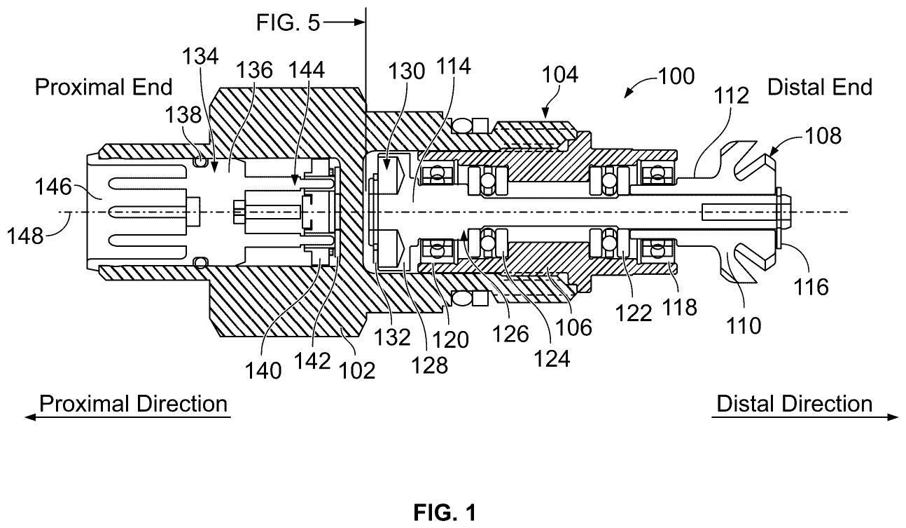

FIG. 1 illustrates a cross-sectional side view of a flow meter insert 100, according to an example implementation. A flow meter insert or an insertion flow meter, is a mechanical device that measures the flow rate of fluids in pipes or manifolds, for example. The flow meter insert thus cooperates with another components (e.g., a manifold) to measure flow rate of fluid (e.g., water or hydraulic fluid).

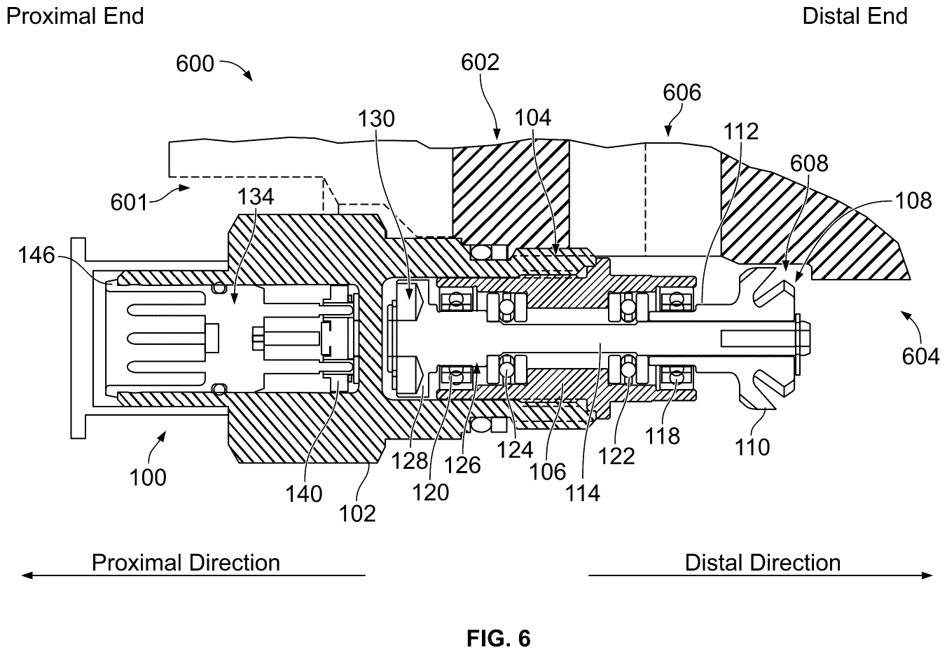

The flow meter insert 100 includes a housing 102 having a longitudinal cylindrical cavity therein. The housing 102 has external threads 104 to facilitate inserting and screwing the flow meter insert 100 into a manifold having fluid ports, for example, as described below with respect to FIG. 6.

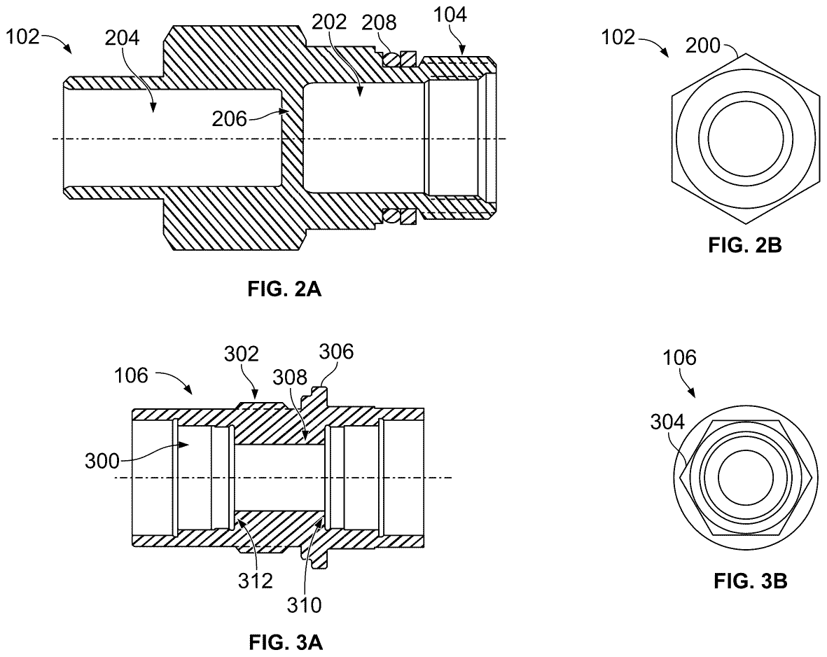

FIG. 2A illustrates a cross-sectional side view of the housing 102, and FIG. 2B illustrates a front view of the housing 102, according to an example implementation. The housing 102 is generally cylindrical, and may have a hexagonal portion 200 shown in FIG. 2B to facilitate grabbing and screwing the housing 102 in a manifold, for example.

The housing 102 has a first chamber 202 separated from a second chamber 204 via a wall or partition 206. The housing 102 is configured to be made of a nonmagnetic material such as any nonmagnetic steel, for example. A radial seal 208 may be mounted around the housing 102 to seal against an interior surface of a manifold in which the housing 102 is screwed, for example.

Referring to FIGS. 1, 2A together, the flow meter insert 100 may include a holder 106 disposed, at least partially, in the first chamber 202 of the housing 102. The holder 106 is configured to hold or accommodate some components (e.g., multiple bearings) of the flow meter insert 100 therein.

FIG. 3A illustrates a cross-sectional side view of the holder 106, and FIG. 3B illustrates a front view of the holder 106, according to an example implementation. The holder 106 is generally cylindrical and hollow, forming a cavity 300 (e.g., a continuous cylindrical cavity or channel) therein. The holder 106 may have external threads 302 and may have a hexagonal portion 304 shown in FIG. 3B to facilitate grabbing and screwing the holder 106 into the housing 102 via the external threads 302, for example.

For example, referring to FIGS. 1, 3A together, the holder 106 can be inserted in a proximal direction until a protruded rim 306 of the holder 106 contacts the distal end of the housing 102, which acts as a stop for the holder 106. Further, as shown in FIG. 3A, the holder 106 has an internal protrusion 308 that narrows the cavity 300, thereby forming a distal shoulder 310 and a proximal shoulder 312. In an example, the holder 106 may be made of a magnetic material such as 12L14 steel.

Referring back to FIG. 1, the flow meter insert 100 includes a turbine 108. The turbine 108 includes an impeller 110 that is mounted to or integrated with a turbine shaft 112. The turbine shaft 112 extends axially in a proximal direction as shown in FIG. 1. The turbine 108 may be made of a plastic material in an example.

In an example, the turbine 108 is hollow to accommodate a shaft 114 therethrough. The shaft 114 is mounted through the longitudinal cavity of the housing 102 and the cavity 300 of the holder 106. As depicted, the shaft 114 extends distally outward from the housing 102, and the impeller 110 is disposed at or proximate a distal end of the shaft 114. With this configuration, the impeller 110 is mounted external to the housing 102 (e.g., not within the housing 102). As described below, mounting the impeller 110 outside the housing 102 enables placing the impeller 110 in a larger space, reducing pressure drop thereacross and enhancing efficiency. This configuration also enables using a larger turbine.

The turbine 108 may be retained or secured axially to the shaft 114 via a snap ring 116, for example. The turbine 108 is also rotatably coupled to the shaft 114 such that rotation of the turbine 108 causes the shaft 114 to rotate therewith.

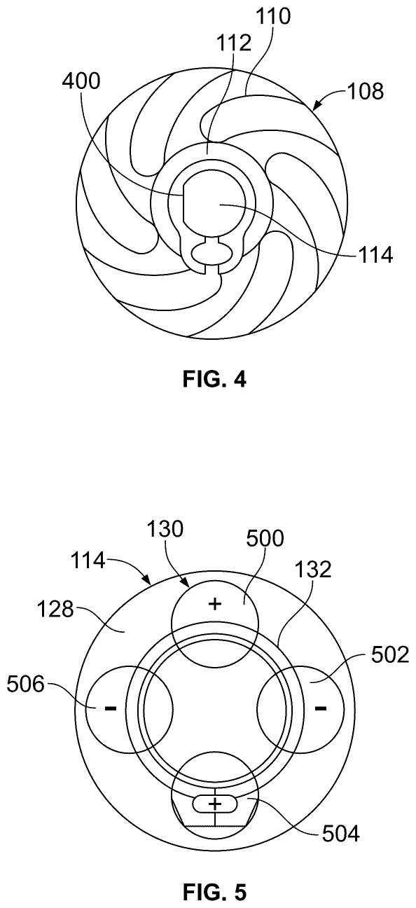

FIG. 4 illustrates a partial front view of the flow meter insert 100, according to an example implementation. In the example implementation of FIGS. 1, 4, an interior peripheral surface of the turbine shaft 112 has a flat portion 400. The shaft 114 also has a corresponding exterior flat portion that interfaces with the flat portion 400. This way, rotation of the turbine 108 causes torque to be transmitted to the shaft 114, causing it to rotate as well.

Other methods of rotatably coupling the turbine 108 to the shaft 114 are contemplated. For example, a key-keyway arrangement, a self-holding taper arrangement, or spline arrangement might be used.

Referring back to FIG. 1, the flow meter insert 100 includes multiple bearings. Particularly, the flow meter insert 100 includes both radial and thrust bearings to carry radial and axial loads, respectively, resulting from fluid flow across the impeller 110.

For example, the flow meter insert 100 includes a distal radial bearing 118 mounted to the turbine shaft 112 within the holder 106 such that the distal radial bearing 118 is radially interposed between the turbine shaft 112 and the holder 106. With this configuration, the distal radial bearing 118 facilitates rotation of the turbine 108 and the shaft 114 relative to the holder 106, supports a distal end of the shaft 114, and may carry radial loads resulting from fluid flow across the impeller 110.

The flow meter insert 100 also includes a proximal radial bearing 120 mounted to the shaft 114 within the holder 106 such that the proximal radial bearing 120 is radially interposed between the shaft 114 and the holder 106. With this configuration, the proximal radial bearing 120 also facilitates rotation of the shaft 114 relative to the holder 106, supports a proximal end of the shaft 114, and may carry radial loads resulting from fluid flow across the impeller 110.

Although the radial bearings 118, 120 are shown as ball bearings, other configurations might be used. For example, bushings or inserts (e.g., bronze inserts) might be used. While ball bearings might be suitable for some applications (e.g., with expected large radial loads and flow rates), the other types of radial bearings (e.g., bushings or inserts) might be suitable for applications where lower flow rates and radial loads are expected.

Further, the flow meter inserts 100 includes one or more thrust bearings to carry axial loads. The flow meter insert 100 can be used in bi-directional applications where flow can flow from a first port to a second port and also from the second port to the first port as described below with respect to FIG. 6. As such, it may be desirable to have two thrust bearings in such applications to carry axial loads in both directions. However, in other applications wherein flow is expected in one direction, one thrust bearing might be used.

Particularly, the flow meter insert 100 may include a distal thrust bearing 122 mounted to the shaft 114 within the holder 106 such that the distal thrust bearing 122 is radially interposed between the shaft 114 and the holder 106. Also, referring to FIGS. 1, 3A together, the distal thrust bearing 122 is interposed axially between a proximal end of the turbine shaft 112 and the distal shoulder 310 formed within the holder 106. With this configuration, the distal thrust bearing 122 facilitates rotation of the turbine 108 and the shaft 114 relative to the holder 106, and carries axial loads resulting from fluid flow across the impeller 110 and acting on the turbine 108 and the shaft 114 in the proximal direction.

Similarly, as shown in FIG. 1, the flow meter insert 100 may also include a proximal thrust bearing 124 mounted to the shaft 114 within the holder 106 such that the proximal thrust bearing 124 is radially interposed between the shaft 114 and the holder 106. Also, referring to FIGS. 1, 3A together, the proximal thrust bearing 124 is interposed axially between a shoulder 126 formed in the shaft 114 and the proximal shoulder 312 formed within the holder 106. With this configuration, the proximal thrust bearing 124 facilitates rotation of the turbine 108 and the shaft 114 relative to the holder 106, and carries axial loads resulting from fluid flow across the impeller 110 and acting on the turbine 108 and the shaft 114 in the distal direction.

As shown in FIG. 1, the shaft 114 has an enlarged diameter portion 128 at the proximal end of the shaft 114. The enlarged diameter portion 128 is configured as a magnet carrier and may have a plurality of receptacles or blind holes formed in a circular array about the proximal end of the shaft 114. The blinds holes are configured to receive a plurality of magnets 130 therein.

The plurality of magnets 130 are retained axially within their respective blind holes via a snap ring 132 mounted externally to the shaft 114. The snap ring 132 is made of a nonmagnetic material for example.

FIG. 5 illustrates a partial rear view of the shaft 114 with the plurality of magnets 130 disposed therein, according to an example implementation. In the example implementation of FIG. 5, four magnets are used. However, in other example implementation other even number of magnets might be used (e.g., two, six, eight, etc.).

As shown in FIG. 5, the plurality of magnets 130 are disposed in a circular array within the enlarged diameter portion 128 of the shaft 114. The plurality of magnets 130 include magnet 500, magnet 502, magnet 504, and magnet 506. The magnets 500-506 have alternating or interleaving polarity such that each magnet with a particular polarity is surrounded circularly by two adjacent magnets of an opposite polarity. For instance, in the example implementation of FIG. 5, the magnet 500 has a positive polarity, the magnet 502 has a negative polarity, the magnet 504 has a positive polarity, and the magnet 506 has a negative polarity.

With this configuration, each two magnets that are disposed diametrically opposite from each other have the same polarity. For instance, the magnets 500, 504 have the same polarity (e.g., positive) and the magnets 502, 506 have the same polarity (e.g., negative).

Each positive magnet has two negative adjacent magnets and vice versa. Particularly, the magnet 500, which has a positive polarity, is surrounded circularly by the magnet 502 on one side and the magnet 506 on the other side, where both of the magnets 502, 506 have a negative or opposite polarity, and so on. This configuration enables detecting, not only the speed of rotation of the shaft 114, but also the direction of rotation of the shaft 114.

Referring to FIGS. 1, 2A together, the first chamber 202 of the housing 102 accommodates a portion of the shaft 114, the enlarged diameter portion 128 thereof, and the plurality of magnets 130 mounted therein. The second chamber 204 houses or contains a sensor 134 such that the sensor 134 is separated from the plurality of magnet 130 via the partition 206.

In an example, the sensor 134 is configured as a Hall-Effect sensor. The sensor 134 has a sensor body 136 retained within the second chamber 204 of the housing 102 via a retention ring 138.

The sensor 134 may further include a printed circuit board (PCB) 140. The PCB 140 is mounted at a distal end of the sensor 134 and electrically isolated from the partition 206 of the housing 102 by a washer 142. Particularly, the washer 142 is configured to be electrically nonconductive to electrically isolate the PCB 140 from the housing 102 and prevent short circuits. For example, the washer 142 can be made of fiber (e.g., hard fiber), plastic, polymer, an organic material, etc.

The PCB 140 is a circuit board that mechanically supports and electrically connects electronic components (e.g., microprocessors, integrated chips, capacitors, resistors, transistors, sensor chips, etc.) using conductive tracks, pads, and other features etched from one or more sheet layers of copper laminate onto and/or between sheet layers of a nonconductive substrate. Components are generally soldered onto the PCB to both electrically connect and mechanically fasten them to it.

Particularly, in an example, the PCB 140 has Hall-Effect sensors mounted thereto. Such Hall-Effector sensors are configured to determine a revolutions count and the direction of rotation of the shaft 114 (and thus of the turbine 108) by detecting variation in magnetic field of the plurality of magnets 130 as the shaft 114 rotates. For example, the Hall-Effect sensors are configured to measure a voltage change that occurs when the Hall-Effect sensors are placed in a varying magnetic field.

In an example, a Hall-Effect sensor may include a thin layer of conductive material, like silicon, gallium arsenide, or indium antimonide, and such layer forms the Hall plate. When a magnetic field is perpendicular to the Hall plate, and an electric current passes through it, a Hall voltage is generated across the plate. The Hall-Effect sensor then measures the voltage to determine the magnetic field's strength, polarity, and magnitude. For example, the frequency of the voltage signal may indicate variation in the magnetic field's strength and/or magnitude.

Thus, by detecting changes in the magnetic field (e.g., changes in magnetic field intensity/strength), the Hall-Effect sensors can count the revolutions of the shaft 114, and thus the speed of rotation of the shaft 114. The speed of rotation of the shaft 114 is the speed of rotation of the turbine 108, and is thus indicative of the flow rate of fluid causing the turbine 108 to rotate.

Further, the Hall-Effect sensors of the PCB 140 are also capable of detecting the direction of rotation of the shaft 114 (and thus the direction of fluid flow) by detecting the sequence of magnet polarity changes. For example, the PCB 140 may be able to detect whether the sequence of polarity change is positive to negative to positive to negative, or conversely negative to positive to negative to positive, and thus determine in which direction the shaft 114 rotates.

As shown in FIG. 1, the PCB 140 is retained via pins 144, which also electrically couple the PCB 140 to a connector 146 of the sensor 134 to conduct signals to and from the PCB 140. For example, the connector 146 may be an M12 connector with four pins such as pin 148. The four pins may: (i) provide a supply voltage (e.g., 5 volts) to the PCB 140, (ii) connect the PCB 140 to ground, (iii) receive a digital signal from the PCB 140 that changes between 5 volts and 0 volts when the Hall-Effect sensors of the PCB 140 detect a change in the magnetic field from plus to minus, and (iv) receive a direction signal from the PCB 140.

A controller (e.g., a microprocessor) of a fluid system may receive such signals via the connector 146 to determine the flow rate and direction. The controller may then responsively send commands to other components of the system, for example.

As mentioned above the flow meter insert 100 is configured to be screwed or inserted into a manifold. Such manifold may have at least two ports, and may allow fluid flow from one port to the other. As fluid flows from one port to the other, fluid flows across the impeller 110 of the turbine 108, thereby causing the turbine 108 to rotate.

FIG. 6 illustrates a partial cross-sectional view of an assembly 600 of the flow meter insert 100 disposed in a manifold cavity 601 of a manifold 602, according to an example implementation. The manifold 602 may be a component in a fluid system that controls the flow of fluid between pumps, actuators, valves, and other components of the fluid system. The manifold 602 is typically configured as a block (e.g., casting or machined block made of aluminum, steel, cast iron, etc.) with various fluid passages and ports such as a first port 604 and a second port 606.

As shown in FIG. 6, the flow meter insert 100 can be screwed into the manifold 602 via the external threads 104 of the housing 102, for example. The manifold 602 has a recess 608 (e.g., an internal annular groove) that accommodates or receives the impeller 110 of the flow meter insert 100. As fluid flows from the first port 604 to the second port 606 or conversely from the second port 606 to the first port 604, fluid causes the impeller 110 to rotate, thereby causing the shaft 114 to rotate therewith. The sensor 134 then generates one or more signals indicative of the rotational speed and the direction of rotation of the shaft 114 and the turbine 108 via interacting with the plurality of magnets 130 mounted to the shaft 114.

Particularly, if fluid flows from the first port 604 axially through the manifold 602, across the impeller 110, then radially outward through the second port 606, the impeller 110 rotates in a first direction. In this case, the axial load on the turbine 108 and the shaft 114 may be carried by the distal thrust bearing 122. The radial loads may be carried by both of the radial bearings 118, 120.

As the impeller 110 rotates, the shaft 114 rotates, and the plurality of magnets 130 rotate therewith. The Hall-Effect sensors of the PCB 140 sense the variations in the magnetic field and outputs a signal (e.g., voltage signal) indicating the speed of rotation of the impeller 110 and the shaft 114, which is indicative of the fluid flow rate. For example, the frequency of the voltage signal may indicate the speed of rotation of the shaft 114.

Thus, the flow meter insert 100 operates by creating a magnetic field that reverses rapidly as the shaft 114 rotates. As a fluid flows and rotates the impeller 110, the variations in the magnetic field generated by the plurality of magnets 130 moves through the field, generates a voltage that is measured and translated into a frequency signal. The frequency signal may be proportional to the flow rate of the fluid. Also, the direction of fluid flow (e.g., from the first port 604 to the second port 606) is indicated by sensing the sequence of magnetic polarity change as mentioned above.

Similarly, if fluid flows from the second port 606 radially into the manifold cavity 601 of the manifold 602, across the impeller 110, then axially to the first port 604, the impeller 110 rotates in a second direction (opposite the first direction). In this case, the axial load on the turbine 108 and the shaft 114 may be carried by the proximal thrust bearing 124. The radial loads may be carried by both of the radial bearings 118, 120.

As the impeller 110 rotates, the shaft 114 rotates, and the plurality of magnets 130 rotate therewith. The Hall-Effect sensors of the PCB 140 sense the variations in the magnetic field and outputs a signal (e.g., voltage signal) indicating the speed of rotation of the impeller 110 and the shaft 114, which is indicative of the fluid flow rate. Also, the direction of fluid flow (e.g., from the second port 606 to the first port 604) is indicated by sensing the sequence of magnetic polarity change.

Notably, by placing the turbine 108, and particularly the impeller 110, outside the housing 102 and the holder 106, the space available for the impeller 110 (e.g., as defined by the recess 608 of the manifold 602) may be larger compared to a configuration where an impeller is disposed within a housing of an insert. Therefore, the pressure drop across the flow meter insert 100 may be reduced, compared to such configurations where the impeller is disposed within the housing. Also, a larger turbine can be used.

Further, conventional configurations involve using a sleeve within which the turbine is disposed. Such sleeve required a precisely machine cavity. With the configurations disclosed herein involving mounting the impeller 110 outside the housing 102, the sleeve is eliminated. By eliminating the sleeve, the impeller 110 rotates within a cavity in the manifold 602. The clearance between the impeller 110 and the cavity (the recess 608) can be larger than between a sleeve and cavity of a convention configuration. Thus, the cavity of the manifold 602 that accommodates the flow meter insert 100 is easier to machine.

For example, a reaming process might not be needed). Also, the geometry of the turbine 108 or the impeller 110 are not constrained by an inner diameter of a sleeve. Thus, the impeller 110 can be scaled up or down in size based on the application and the cavity within the manifold 602.

Further, in examples, the turbine 108 may be made using additive manufacturing processes such as three-dimensional (3D) printing. As such, different turbines with different outer diameters and different shapes (e.g., cylindrical, conical, etc.) can be implemented. This facilitates adaptation to different manifolds, while in conventional configurations with sleeves, manufacturing such sleeves for different cavities is more difficult.

Further, in some applications, there might not be not enough space for a sleeve. For example, in a coupler application, a coupler manifold might not have enough space for a sleeve. Thus, the configuration of the flow meter insert 100 enables using a flow meter in such an application.

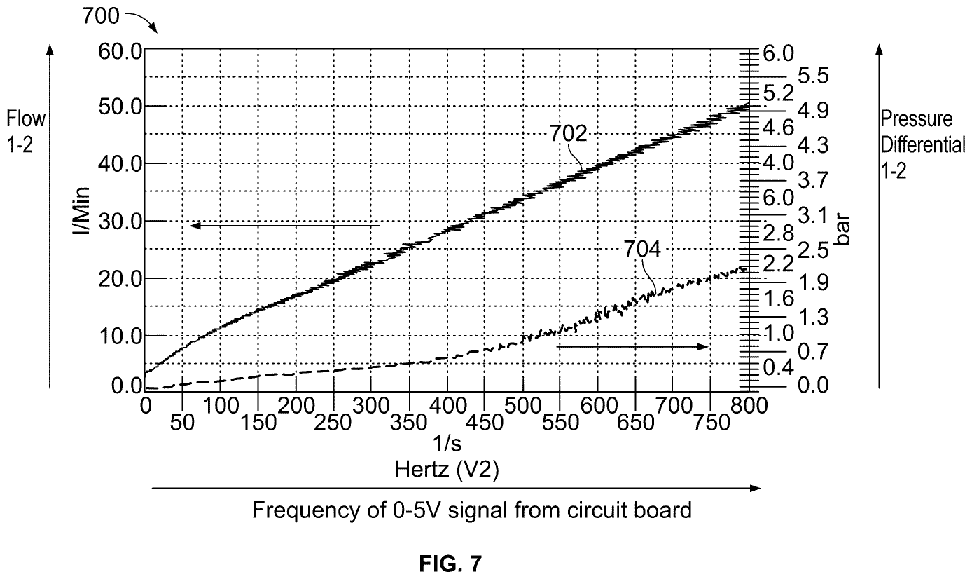

FIG. 7 is a graph 700 showing frequency of a signal generated by the flow meter insert 100 versus actual fluid flow rate, according to an example implementation. Particularly, the left y-axis indicates fluid flow rate as measured by an inline flow meter indicating actual fluid flow rate from the first port 604 to the second port 606 of the manifold 602 in liters per minute (l/min). The x-axis shows the frequency of the 0-5 volt signal generated by the sensor 134 (e.g., by the Hall-Effect sensors of the PCB 140) in Hertz.

Line 702 plots a correlation between the frequency of the signal generated by the sensor 134 and the actual flow rate measured by the inline flow rate sensor. As shown, the correlation is substantially linear, indicating the level of accuracy of the flow meter insert 100. Particularly, for flow rates less than about 12 l/min, there is some non-linearity; however, above 12 l/min, the correlation is substantially linear.

The right y-axis of the graph 700 indicates pressure in bar. Line 704 of the graph 700 plots the pressure drop (e.g., decrease in pressure level as fluid flows from the first port 604 to the second port 606 across the impeller 110) in bar. As shown by the line 704, the pressure drop remains small (e.g., less than about 0.5 bar) when the flow rate is less than or equal to about 30 l/min. Such pressure drop is much less than pressure drops of conventional flow meter inserts, which can be up to 8 bar.

As such, this flow meter insert may be rated for flow rates up to 30 l/min. Larger inserts might be used for higher flow rates and smaller inserts might be used for lower flow rates, and thus the flow meter insert 100 is scalable.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a flow meter insert comprising: a housing; a shaft mounted partially within the housing such that the shaft protrudes outside the housing; a turbine that is rotatably coupled to the shaft, wherein the turbine comprises an impeller mounted to the shaft external to the housing; a plurality of magnets, wherein the turbine is configured to rotate as fluid flows across the impeller, thereby causing the plurality of magnets to rotate therewith; and a sensor mounted adjacent the plurality of magnets to detect variation in a magnetic field as the plurality of magnets rotate along with the impeller, wherein, based on detecting the variation, the sensor is configured to provide information indicative of a count of revolutions and direction of rotation of the impeller to facilitate determining fluid flow rate and direction of fluid flow.

EEE 2 is the flow meter insert of EEE 1, further comprising: one or more radial bearings mounted to the shaft to carry radial loads and facilitate rotation of the shaft and the turbine coupled thereto; and one or more thrust bearings mounted to the shaft to carry axial loads as fluid flows across the impeller.

EEE 3 is the flow meter insert of any of EEEs 1-2, wherein the housing comprises external threads to facilitate screwing the housing into a manifold.

EEE 4 is the flow meter insert of any of EEEs 1-3, wherein the housing comprises a nonmagnetic material.

EEE 5 is the flow meter insert of any of EEEs 1-4, wherein the housing comprises a first chamber and a second chamber, wherein the first chamber is separated from the second chamber via a partition.

EEE 6 is the flow meter insert of EEE 5, wherein the shaft is disposed partially within and the first chamber, and wherein the plurality of magnets are mounted to the shaft and disposed within the first chamber adjacent the partition, and wherein the sensor is mounted in the second chamber.

EEE 7 is the flow meter insert of EEE 6, wherein the sensor comprises a printed circuit board (PCB) that is separated from the partition via a washer that is electrically nonconductive.

EEE 8 is the flow meter insert of EEE 7, wherein the PCB comprises one or more Hall-Effect sensors configured to detect the variation in the magnetic field as the plurality of magnets rotate.

EEE 9 is the flow meter insert of any of EEEs 5-8, further comprising: a holder mounted into the first chamber, wherein the shaft is mounted at least partially within the holder.

EEE 10 is the flow meter insert of EEE 9, further comprising: one or more radial bearings mounted to the shaft within the holder; and one or more thrust bearings mounted to the shaft within the holder.

EEE 11 is the flow meter insert of any of EEEs 9-10, wherein the holder is made of a magnetic material.

EEE 12 is the flow meter insert of any of EEEs 9-11, wherein the turbine further comprises a turbine shaft to which is the impeller is mounted or integrated, wherein an interior peripheral surface of the turbine shaft has a flat portion, and wherein the shaft has a corresponding exterior flat portion that interfaces with the flat portion of the turbine shaft, thereby enabling transmission of torque from the impeller to the shaft.

EEE 13 is the flow meter insert of any of EEEs 1-12, wherein the shaft has an enlarged diameter portion formed at a proximal end of the shaft, wherein the enlarged diameter portion is configured as a magnet carrier having a plurality of blind holes formed in a circular array about the proximal end of the shaft, and wherein the plurality of blinds holes are configured to receive the plurality of magnets respectively therein.

EEE 14 is the flow meter insert of EEE 13, wherein the plurality of magnets are retained axially within respective blind holes of the shaft via a snap ring mounted externally to the shaft, and wherein the snap ring is made of a nonmagnetic material.

EEE 15 is the flow meter insert of any of EEEs 13-14, wherein the plurality of magnets have interleaving polarity such that each magnet with a particular polarity is surrounded circularly by two adjacent magnets of an opposite polarity.

EEE 16 is the flow meter insert of EEE 15, wherein each two magnets that are disposed diametrically opposite from each other have same polarity.

EEE 17 is an assembly comprising: a manifold having a manifold cavity, a first port, a second port, and a recess; and the flow meter insert of any of EEEs 1-16 inserted into the manifold. For example, the flow mater insert comprises: a housing mounted in the manifold cavity, a shaft mounted partially within the housing such that the shaft protrudes outside the housing, a turbine that is rotatably coupled to the shaft, wherein the turbine comprises an impeller mounted to the shaft such that the impeller is external to the housing and accommodated within the recess of the manifold, a plurality of magnets, wherein the turbine is configured to rotate as fluid flows from the first port across the impeller to the second port or from the second port across the impeller to the first port, thereby causing the shaft and the plurality of magnets to rotate therewith, and a sensor mounted adjacent the plurality of magnets to detect variation in a magnetic field as the plurality of magnets rotate along with the shaft and the impeller, wherein, based on detecting the variation, the sensor is configured to provide information indicative of a count of revolutions and direction of rotation of the impeller to facilitate determining fluid flow rate and direction of fluid flow.

EEE 18 is the assembly of EEE 17, wherein the housing comprises a first chamber and a second chamber, wherein the first chamber is separated from the second chamber via a partition, wherein the flow meter insert further comprises: a holder that is mounted into the first chamber, wherein the shaft is mounted at least partially within the holder such that the plurality of magnets are mounted to the shaft and disposed within the first chamber adjacent the partition, and wherein the sensor is mounted in the second chamber.

EEE 19 is the assembly of EEE 18, wherein the sensor comprises a printed circuit board (PCB) that is separated from the partition via a washer that is electrically nonconductive.

EEE 20 is the assembly of any of EEEs 18-19, wherein the flow meter insert further comprises: one or more radial bearings mounted to the shaft within the holder; and one or more thrust bearings mounted to the shaft within the holder.

EEE 21 is a method of assembling the flow meter insert of any of EEEs 1-16 or the assembly of any of EEEs 17-20.

EEE 22 is a method of operating the flow meter insert of any of EEEs 1-16 or the assembly of any of EEEs 17-20.

What is claimed is:

1. A flow meter insert comprising:
a housing;
a shaft mounted partially within the housing such that the shaft protrudes outside the housing;
a turbine that is rotatably coupled to the shaft, wherein the turbine comprises an impeller mounted to the shaft external to the housing;
a plurality of magnets, wherein the turbine is configured to rotate as fluid flows across the impeller, thereby causing the plurality of magnets to rotate therewith; and
a sensor mounted adjacent the plurality of magnets to detect variation in a magnetic field as the plurality of magnets rotate along with the impeller, wherein, based on detecting the variation, the sensor is configured to provide information indicative of a count of revolutions and direction of rotation of the impeller to facilitate determining fluid flow rate and direction of fluid flow.

2. The flow meter insert of claim 1, further comprising:
one or more radial bearings mounted to the shaft to carry radial loads and facilitate rotation of the shaft and the turbine coupled thereto; and
one or more thrust bearings mounted to the shaft to carry axial loads as fluid flows across the impeller.

3. The flow meter insert of claim 1, wherein the housing comprises external threads to facilitate screwing the housing into a manifold.

4. The flow meter insert of claim 1, wherein the housing comprises a nonmagnetic material.

5. The flow meter insert of claim 1, wherein the housing comprises a first chamber and a second chamber, wherein the first chamber is separated from the second chamber via a partition.

6. The flow meter insert of claim 5, wherein the shaft is disposed partially within and the first chamber, and wherein the plurality of magnets are mounted to the shaft and disposed within the first chamber adjacent the partition, and wherein the sensor is mounted in the second chamber.

7. The flow meter insert of claim 6, wherein the sensor comprises a printed circuit board (PCB) that is separated from the partition via a washer that is electrically nonconductive.

8. The flow meter insert of claim 7, wherein the PCB comprises one or more Hall-Effect sensors configured to detect the variation in the magnetic field as the plurality of magnets rotate.

9. The flow meter insert of claim 5, further comprising:
a holder mounted into the first chamber, wherein the shaft is mounted at least partially within the holder.

10. The flow meter insert of claim 9, further comprising:
one or more radial bearings mounted to the shaft within the holder; and
one or more thrust bearings mounted to the shaft within the holder.

11. The flow meter insert of claim 9, wherein the holder is made of a magnetic material.

12. The flow meter insert of claim 9, wherein the turbine further comprises a turbine shaft to which is the impeller is mounted or integrated, wherein an interior peripheral surface of the turbine shaft has a flat portion, and wherein the shaft has a corresponding exterior flat portion that interfaces with the flat portion of the turbine shaft, thereby enabling transmission of torque from the impeller to the shaft.

13. The flow meter insert of claim 1, wherein the shaft has an enlarged diameter portion formed at a proximal end of the shaft, wherein the enlarged diameter portion is configured as a magnet carrier having a plurality of blind holes formed in a circular array about the proximal end of the shaft, and wherein the plurality of blinds holes are configured to receive the plurality of magnets respectively therein.

14. The flow meter insert of claim 13, wherein the plurality of magnets are retained axially within respective blind holes of the shaft via a snap ring mounted externally to the shaft, and wherein the snap ring is made of a nonmagnetic material.

15. The flow meter insert of claim 13, wherein the plurality of magnets have interleaving polarity such that each magnet with a particular polarity is surrounded circularly by two adjacent magnets of an opposite polarity.

16. The flow meter insert of claim 15, wherein each two magnets that are disposed diametrically opposite from each other have same polarity.

17. An assembly comprising:
a manifold having a manifold cavity, a first port, a second port, and a recess; and
a flow meter insert comprising:
a housing mounted in the manifold cavity,
a shaft mounted partially within the housing such that the shaft protrudes outside the housing,
a turbine that is rotatably coupled to the shaft, wherein the turbine comprises an impeller mounted to the shaft such that the impeller is external to the housing and accommodated within the recess of the manifold,
a plurality of magnets, wherein the turbine is configured to rotate as fluid flows from the first port across the impeller to the second port or from the second port across the impeller to the first port, thereby causing the shaft and the plurality of magnets to rotate therewith, and
a sensor mounted adjacent the plurality of magnets to detect variation in a magnetic field as the plurality of magnets rotate along with the shaft and the impeller, wherein, based on detecting the variation, the sensor is configured to provide information indicative of a count of revolutions and direction of rotation of the impeller to facilitate determining fluid flow rate and direction of fluid flow.

18. The assembly of claim 17, wherein the housing comprises a first chamber and a second chamber, wherein the first chamber is separated from the second chamber via a partition, wherein the flow meter insert further comprises:
a holder that is mounted into the first chamber, wherein the shaft is mounted at least partially within the holder such that the plurality of magnets are mounted to the shaft and disposed within the first chamber adjacent the partition, and wherein the sensor is mounted in the second chamber.

19. The assembly of claim 18, wherein the sensor comprises a printed circuit board (PCB) that is separated from the partition via a washer that is electrically nonconductive.

20. The assembly of claim 18, wherein the flow meter insert further comprises:
one or more radial bearings mounted to the shaft within the holder; and
one or more thrust bearings mounted to the shaft within the holder.
